(19) United States
(12) Patent Application Publication
(10) Pub. No.: US 2017/0127711 A1
(43) Pub. Date: May 11, 2017

(54) PACKAGED FOOD PRODUCT AND METHOD

(71) Applicant: Nutrient Vending, LLC, Atlantis, FL (US)

(72) Inventors: Travis Sherman, Atlantis, FL (US); Kevin Reilly, Stuart, FL (US)

(21) Appl. No.: 15/337,040

(22) Filed: Oct. 28, 2016

Related U.S. Application Data
(60) Provisional application No. 62/251,416, filed on Nov. 5, 2015.

(51) Int. Cl. A23L 33/10; A23L 2/52

(52) U.S. Cl. CPC A23L 33/10; A23L 2/52; A23V 2002/00

(57) ABSTRACT

A packaged ingestible product and method are provided. The food product includes a water-soluble package made of a material containing HPMC and a dry ingestible. The ingestible is exposed to water by placing the packaged product into water and allowing the water to solubilize the soluble package.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/251,416, entitled, “PACKAGED FOOD PRODUCT AND METHOD”, filed Nov. 5, 2015. The contents of the above referenced application are incorporated herein by reference in its entirety.

### FIELD OF THE INVENTION

The present invention is directed to a packaged ingestible, such as a food product to be combined with water prior to consumption. The ingestible product can be either soluble or wettable. The package is adapted to contain the ingestible during shipping and storage, and readily dissolve when placed in contact with water, but remain intact during storage and shipping, even in high humidity environments.

### BACKGROUND OF THE INVENTION

Ingestibles, such as food products in packages, are extremely well known in the art. Packaging is used to protect the ingestible from the environment and contamination. Typically, the package is separated from the ingestible prior to consumption of the ingestible and is disposed of. Such packaging can be rigid or flexible. Such packaging can be comprised of metal, polymers, paper and the like. Also, such packaging can be used as a delivery vehicle for the ingestible to the consumer as is currently found in some baby food pouches and drink pouches.

Society now is “on the move”, and the lifestyle of leaving home, going to work and returning home for many people has been abandoned in favor of a more active lifestyle. Rather, people indulge in many activities outside of the home, necessitating major changes in schedules and nutrition. Such pursuits include activities such as running, biking, walking, fitness clubs and the like. Some of these pursuits are believed to require special nutrition. They also make eating on a classical schedule difficult. Further, many people concern themselves more now with what they ingest.

These new lifestyles make the consumption of food and other ingestibles more difficult because people are not in areas conducive to the consumption of ingestibles in the normal manner. This is particularly true for solid foods, which normally require the use of utensils and dishes. Such solid foods typically have a high moisture content and large volume, which makes their consumption even more difficult.

There is thus a need for the ability to provide packaged ingestibles in a dry form that can be conveniently placed in contact with water for hydration and subsequent consumption.

### DESCRIPTION OF THE PRIOR ART

Numerous types of ingestible packaging are known in the art. They typically provide a barrier to the ingress or egress of moisture, contamination and often oxygen migration. In many cases, they should also be constructed to withstand processing of the product therein, which can involve high temperatures and high pressures. Such packaging can be rigid or flexible and constructed of metal, glass, paper and plastics. Recently, there have also been materials presented that can be used to form water-soluble food packaging.

### SUMMARY OF THE INVENTION

The invention relates to a packaged ingestible that can be transported in a dry state and added to a water containing liquid to release the ingestible into the water. The package is soluble in the water and when dissolved, has little, if any, effect on the properties of the subsequent mixture of hydrated product or its appearance.

Accordingly, it is a primary objective of the instant invention to provide a dry ingestible in a water-soluble package.

It is a further objective of the instant invention to provide a packaged dry ingestible that is resistant to environmental compromise of the soluble package and can be easily and discreetly carried by a consumer.

It is a still further object to provide such a packaged product that can be easily placed in a variety of different containers having water therein.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a side view of a packaged food product with a portion broken away to show a food product inside the package; and

FIG. 2 is a perspective view of a plurality of packaged food products contained in a shipping container with portions broken away to show internal details.

### DETAILED DESCRIPTION OF THE INVENTION

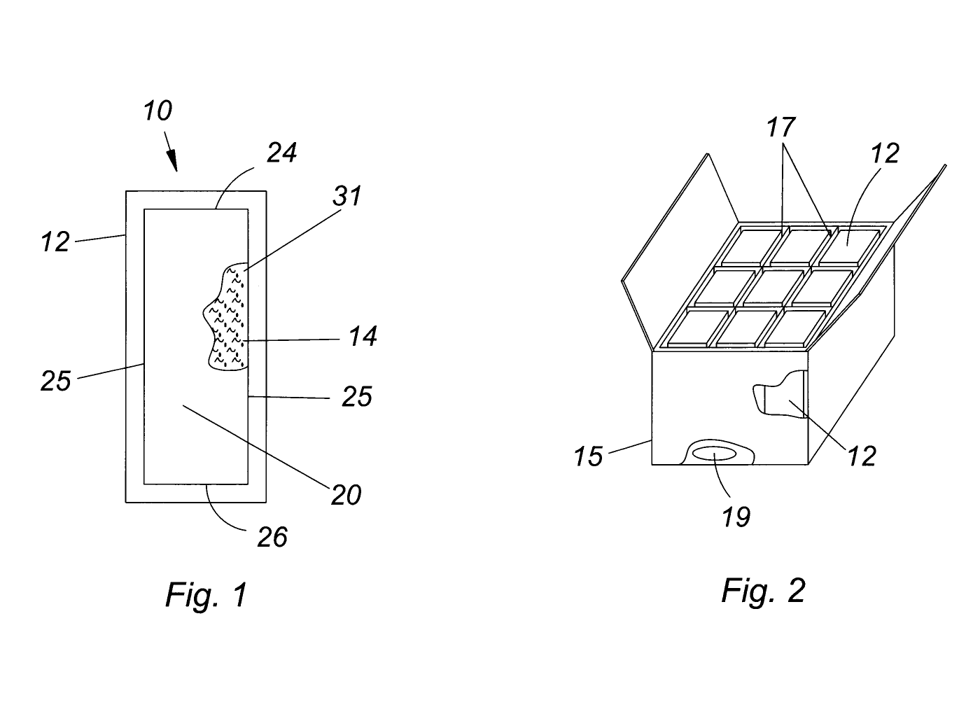

Referring to FIGS. 1-2, the reference numeral 10 designates generally a packaged ingestible product comprising a package 12 containing at least one ingestible product 14 that is adapted to be placed in contact with water prior to consumption. A plurality of packaged products 10 can be packed in an outer container 15 for shipping and storage. The container 15 can be made of a suitable material such as corrugated material or a rigid paperboard as are known in the art, and is preferably a rectangular solid. Partitions 17 can be provided to keep the products 10 separated from one another. The partitions 17 can be made of a paperboard or polymeric material as is known in the art. A suitable package of desiccant 19 can also be provided in the container 15 to reduce moisture pickup from the environment by the products 10. A suitable desiccant 19 can be packaged silica gel.

In a preferred embodiment, the ingestible product 14 can include particulates such as powders, granules, clumps and comminuted foods such as oatmeal. The product 14 is ingestible by a human and can include food, supplements, nutraceuticals, pharmaceuticals, BCAA, protein, vitamins, minerals, drink mixes such as tea and coffee, nitric oxide supplement, creatine, amino acids, probiotics, candy, glutamine, baby food, fiber, antacids, meal replacements, processed grains such as oatmeal, combinations thereof and the like. Flavors, sweeteners and spices may also be included. Preferably, the product 14 has a total moisture content of less than about 15% by weight, and more preferably less than about 10% of the total ingestible product 14. A plurality of different products 14 can be contained in a single package 12, for example, protein and sugar. The product 14 in a package 12 is present in a weight range, including moisture, in the range of between about 0.1 ounce (3 grams) and about 6 ounces (170 grams). Nutraceuticals can be present in an amount, including moisture, in the range of about 0.15 ounce (5 grams) to about 0.35 ounce (10 grams). The product 14 can be soluble in water or sufficiently hygroscopic to adsorb or absorb water when placed in contact with the water; an example of such a product 14 would be oatmeal. The product 14 is adapted to be consumed with a higher moisture content than what it is stored at, i.e., water is added to the product 14 prior to consumption. The water can be water alone, or a product containing water, such as a fruit juice, milk or the like.

The ingestible product 14 should be safe for consumption by humans, and preferably be GRAS (generally recognized as safe by the U.S. FDA) or approved by another appropriate government agency. The product 14 should have a shelf life of at least about six months, and should be produced in accordance with good manufacturing practices for food and other ingestibles (GMP).

The package 12 is made from a water-soluble material such as HPMC (hydroxypropyl methylcellulose). The material is in the form of a flexible film having a thickness, other than at a seam described below, in the range of between about 0.001 inches and about 0.010 inches (25 microns-250 microns), and more preferably 0.001 inches and about 0.004 inches (25 microns-100 microns). Its properties are such as to be soluble in water at a water temperature of less than about 140° F. (60° C.), and preferably in the range of between about 33° F. (0.5° C.) and about 120° F. (49° C.). The moisture content of the film material should be less than about 10% by weight. HPMC can have a solubility that decreases with increasing temperature. The water-soluble film material should not gel at its anticipated temperature of use. The molecular weight of the HPMC is preferably in the range of between about 13,000 and about 200,000 gm/mol. It has been found advantageous to add a hydrophobic material to the HPMC to help it resist moisture migration from the outside of the package 12 to the ingestible 14 inside of the package 12. In a preferred embodiment, carnauba wax in powdered form is added to the HPMC prior to its being formed into the film from which the package 12 is formed. The carnauba wax is added to the HPMC in an effective amount of up to about 5% by weight of the HPMC, each on a dry weight basis. The package can be provided with indicia 20 providing information about the product and/or its use. Such indicia can be printed with an edible ink as is known in the art.

The package 12 material should be safe for consumption by humans and, preferably, be GRAS (generally recognized as safe by the U.S. FDA) or approved by an appropriate government agency.

The package 12 in the illustrated structure has at least one seam 24 and, as shown, has the seam 24 as a top seam, two side seams 25 and a bottom seam 26. The seams are permanent and can be formed by heat and applied force as is known in the art. Preferably, the heat is applied by ultrasonic means. Other suitable means of bonding one layer of packaging film to an adjacent layer of packaging film can be utilized, such as the application of water and force. The package could also be formed by a suitable thermoforming process. In the illustrated structure, the package 12 is made from two separate film portions and sealed around the perimeter on four sides, forming a generally rectangular package having a cavity 31 therein. At least a portion of the package 12 should be open to permit filling thereof with the ingestible product 14, and then finally sealed. It is to be understood that the package 12 can be formed with three seals by having one of the seals, for example one side seam 25, eliminated because the film sheet can be folded over. It is also to be understood that the package 12 can be formed by extrusion, and the ingestible 14 can be added in a vertical form-fill-seal type manufacturing process. The package 12 can be used for a single serving, or can be configured with other packages to form a stack serving to provide a plurality of ingestibles for incorporation into a single container of a water containing liquid. Such a stack could be provided in a single separate bulk package as separate packages 12 or conjoined packages 12.

The dimension of the transverse cross sectional perimeter of the packaged product 10 in one embodiment should be such as to permit insertion of the packaged product 10 into a container of water, such as a bottle. In such an embodiment, the perimeter should be on the order of approximately 3 inches in length or less. Preferably, the package 12 is less than about 8 inches in length to facilitate its use with a typical bottle of water or other liquid drink containing water. This would facilitate its ability to be used by insertion into a water bottle having an inside neck diameter of approximately 1 inch or less. Additionally, the package 12 can be provided with empty space, known as slack fill, so the packaged ingestible product 10 is flexible to allow a consumer to reform its shape to facilitate its insertion into a container having water for later consumption. The slack fill can be on the order of up to about 20% by volume, i.e., the volume of uncompressed ingestible 14 is about 80% of the maximum internal volume of the package 12. If flexibility is not needed, as for a package of oatmeal for placing in an open bowl, slack fill would not be needed.

The product 10 can be formed by first forming the package 12, and then adding the ingestible product 14 through an unsealed seam area. The product 10 can also be formed by depositing the ingestible onto one piece of packaging film and placing a second piece of packaging film over the ingestible 14 and first piece of film and sealing the entire perimeter. After filling, the unsealed area is sealed to at least substantially close the package 12. The package 12 can then be added to a container 15. After the container 15 is filled with packages 12, the container 15 is also sealed. In use, a package 12 containing an ingestible 14 is then placed into water. The water will solubilize the package 12, allowing the ingestible 14 to mix with the water; after which the hydrated mixture can be consumed.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention, which are obvious to those skilled in the art, are intended to be within the scope of the following claims.

What is claimed is:

1. A packaged ingestible product for consumption by a human, the product including:
a quantity of an ingestible product in particulate form, said quantity being in an amount of at least about 0.1 ounces, said ingestible having a total moisture content of less than about 15% by weight; and
a package containing said ingestible product, said package having at least one permanent seam and being made from HPMC flexible film and being soluble in water, said package film having a thickness other than at a seam of at least about 0.001 inch.

2. The product of claim 1 wherein said at least one seam being a heat formed seam.

3. The product of claim 2 wherein the film including a hydrophobic material to inhibit moisture absorption by the film.

4. The product of claim 3 wherein the hydrophobic material including carnauba wax.

5. The product of claim 3 wherein the HPMC has molecular weight in the range of between about 13,000 gm/mol and about 200,000 gm/mol.

6. The product of claim 1 wherein the ingestible including at least one of a food, supplement, nutraceutical, pharmaceutical, BCAA, protein, vitamin, mineral, drink mix, nitric oxide supplement, creatine, amino acid, probiotic, candy, glutamine, baby food, fiber, antacid, meal replacement and a processed grain.

7. The product of claim 1 wherein the quantity of ingestible product is in the range of between about 0.1 ounce and about 6 ounces.

8. The product of claim 7 wherein the package has a perimeter and the seam extends around the entire perimeter of the package and is a heat formed seal.

9. The product of claim 1 wherein the package has slack fill of up to about 20% by package volume.

10. A method of forming a hydrated ingestible, the method including:
providing a quantity of ingestible product in particulate form in an amount of at least about 0.1 ounce and having a total moisture content of less than about 15% by weight, said ingestible product being contained in a package having at least one permanent seam and being made from HPMC flexible film that is soluble in water, said package film having a thickness other than at a seam of at least about 0.001 inch;
placing said package and ingestible product in a water containing liquid and dissolving the package and thereby releasing the ingestible product into the water containing liquid for hydration; and
consuming the hydrated ingestible product.

11. The method of claim 10 wherein the ingestible product including at least one of a food, supplement, nutraceutical, pharmaceutical, BCAA, protein, vitamin, mineral, drink mix, nitric oxide supplement, creatine, amino acid, probiotic, candy, glutamine, baby food, fiber, antacid, meal replacement and a processed grain.

12. The method of claim 10 wherein the quantity of ingestible product is in the range of between about 0.1 ounce and about 6 ounces.

13. The method of claim 10 wherein the package has slack fill of up to about 20% by package volume.
